(19) United States
(12) Patent Application Publication
(10) Pub. No.: US 2010/0057537 A1
(43) Pub. Date: Mar. 4, 2010

(54) Online Qualitative Research Support System

(76) Inventor: Jennifer E. Dale, St. John, VI (US)

Correspondence Address: STEVEN W. WEBB, 825 College Blvd., Suite 102620, Oceanside, CA, 92057, US

(21) Appl. No.: 12/507,678

(22) Filed: Jul. 22, 2009

Related U.S. Application Data
(60) Provisional application No. 61/093,711, filed on Sep. 2, 2008.

(51) Int. Cl. G06Q 10/00; G06F 3/048

(52) U.S. Cl. 705/10; 715/757

(57) ABSTRACT

A system and method for coordinating and conducting qualitative research interviews over a distributed communication system is presented. The system is controlled from a central point by the user.

The system features a Virtual Office and a Virtual Discussion Room function that provides functional and visual support for the coordination and execution of the distributed discussion. The virtual office allows the user (moderator) to organize the discussion elements and invite selected attendees. The virtual discussion room allows all attendees to see the same visual media and participate primarily via text interaction with each other and the session moderator.

### RELATED APPLICATIONS

This application claims the benefit of Provisional Application 61/093,711, dated Sep. 2, 2008.

### FIELD OF THE INVENTION

This invention relates to internet-based communication systems that support group discussions and meetings.

### BACKGROUND OF THE INVENTION

The present invention addresses the need for coordinating and executing qualitative research interviews, known as focus groups or in-depth interviews, with a moderator and one or more invited participants distributed over geographic distances. Normally, a focus group is conducted with a group set of participants who are in the same geographic location or the same room and the coordination of that event occurs “off line” and is managed by multiple people and services. Client observers can watch the discussion through two-way glass in an adjoining room.

The process of coordinating the meeting of a geographically dispersed group revolves around organizing the tasks in a format that simulates the office of a qualitative researcher.

The process of interviewing a geographically dispersed group of people in a controlled setting revolves around supporting their interpersonal communications needs in a format that simulates a same-room meeting. This invention is distinct from other prior art which concentrates on distributed meeting support in that specific requirements of coordinating and conducting qualitative research interviews are addressed and provided.

### SUMMARY OF THE INVENTION

A preferred embodiment of the present invention, called a Virtual Focus Facility in its entirety, includes two parts: a Web process application for qualitative researchers to coordinate one or more research events; and a Web communication application in which the interview event actually occurs.

The Web process application, the Virtual Office, enables the user to coordinate the possibility of research interviews among participants, b) schedule and house supporting interview materials, c) notify attendees, d) access the companion Virtual Discussion Room and resulting transcripts, and e) select interview responses to assist in analysis.

The Web communication application, the Virtual Discussion Room, is comprised of one or more research participants and at least one moderator, and also possibly a group administrator and observers, logging onto a Web site at a given time with a specific and integrated group ID and pass code, in the preferred embodiment of an e-mail address and a password.

Once logged onto the network, research participants and the primary moderator communicate in a virtual discussion in which the moderator and observers can view all comments and visual slides presented to participants, and participants can view at least the moderator's questions and their own responses, or all participant responses (a feature set by the user).

Comments can be in the form of text, audio or video (a feature set by the user). Visual slides can be presented in a variety of display modes, including fixed images, videos, audio files or active web pages. On each participant's screen or display device they can view multiple text, audio or video images (features set by the user).

The invention consists of a set of computer software, including programs and routines coded in JAVA, JAVASCRIPT, AJAX and similar languages to control a hierarchical series of web site pages. These pages simulate both the coordination and execution of qualitative research interviews.

The invention possesses art and design factors to minimize user frustration with the nuts and bolts of the distributed system. Users conducting group interviews are encouraged to think of the interview with geographically distributed participant(s) as an in-person discussion.

### OBJECTIVES OF THE PRESENT INVENTION

The objective of the present invention is to provide qualitative researchers an apparatus and methodology for coordinating (in the Virtual Office) and conducting (in the Virtual Discussion Room) interviews among one or more persons over a geographically distributed area.

A further objective of this invention is to provide an intuitive user interface so that users, participants, and observers will feel comfortable with the experience in the Virtual Discussion Room.

### BRIEF DESCRIPTION OF THE DRAWINGS

FIG. 1. Overview of Software

FIG. 2. Detailed View of the Virtual Office ‘10 Steps’

FIG. 3. Detailed View of the Virtual Discussion Room

FIG. 4. Virtual Office Display

FIG. 5A. Moderator/Administrator Display

FIG. 5B. Participant/Observer Display

### DETAILED SPECIFICATION

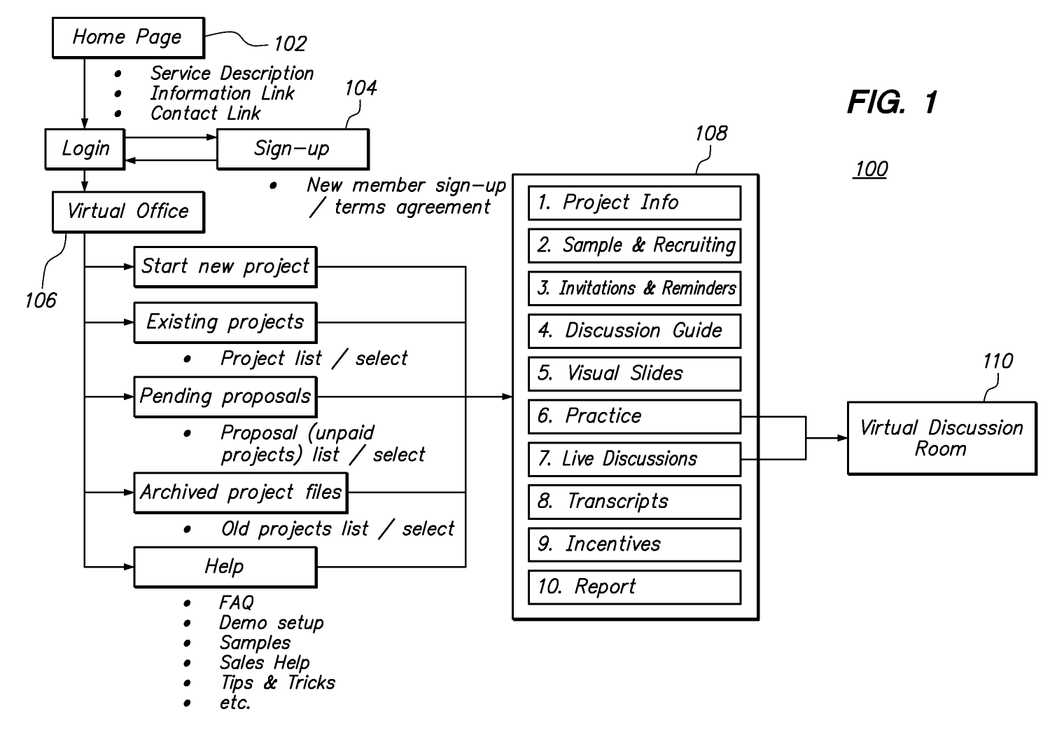

As shown in FIG. 1, the present invention 100 consists of a hierarchically-defined software system running on an underlying network, in the preferred embodiment the underlying network is the Internet. The Internet will be used to support connectivity between the participants being interviewed with a plurality of communication means. These communication means include but are not limited to audio, video and text transmissions, including but not limited to, the moderator's input, input of participants and displays related to the discussion topic.

The invention is broken into several subsystems, which are organized around the screens presented to users (moderators), as well as discussion attendees (moderator, administrator, participants and observers) on their display devices.

Initial steps for use of the system involve registering by means of a login protocol 104, based on e-mail addresses submitted/registered and passwords assigned. This routine is reached by means of browsing to the Home Page 102 provided for the service.

As shown in FIG. 1, The Virtual Office software can manage user input as inventory, respond to user input, and direct user process. The five upper-level functions are Start New Project, Manage Existing Projects, Manage Pending Proposals, Manage Archived Project Files, and a generic Help Area.

The Virtual Office ‘10 Steps’ 108 part of the system can a) manage a plurality of user input, b) post and manage a variety of user input in the appropriate context in a common, pre-established location on the Web, c) send user input to the listed recruiters, d) schedule interviews based on user input e) send user input to the appropriate interview attendees, f) access the interview as a moderator, and g) manage input from attendees after the interview.

The following screens organize the indicated steps of the process.

### Introductory Screen Home Page 102

Service Description, Information, Contact, Login

### Member Login & Sign-Up 104

Login with Email address & password, Member assistance

Sign-Up with Name, Company, Title, Address, State, Country, Zip, Phone, Fax, etc, Terms of Service Agreement

Information, Contact

### Virtual Office 106

Today's Date, Feedback Terms, Privacy Policy, Logout

Start New Project—Data input (‘10 Steps’)

Existing Projects—Access to Projects in Progress

Pending Proposals—Access to Projects Not Yet Confirmed

Archive Project Files—Access to Old Projects

Help—FAQs, Demos, Examples, Sales Help, Account Info, Tips & Tricks, etc.

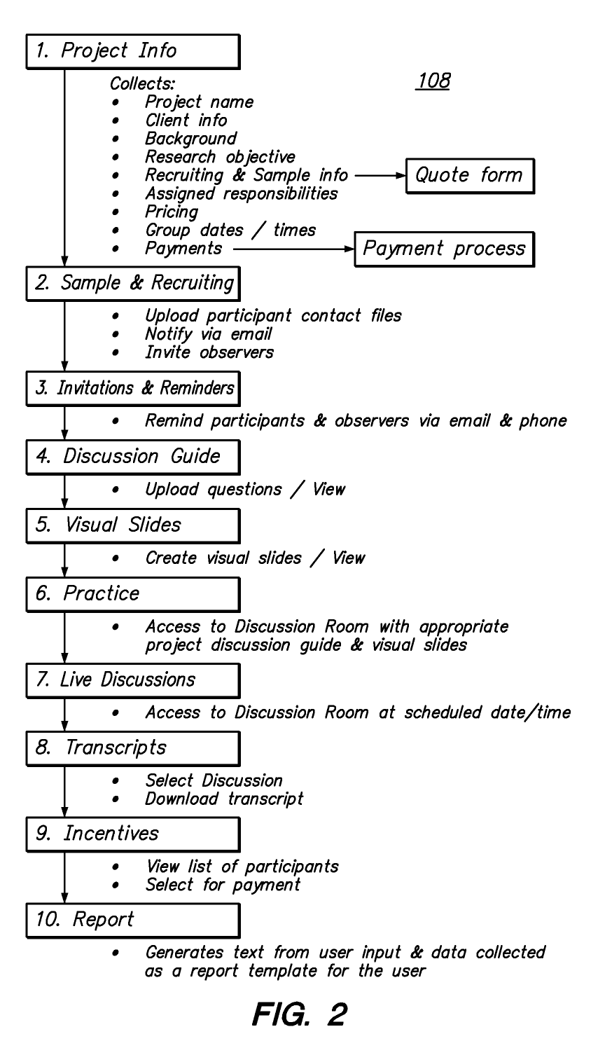

### Virtual Office ‘10 Steps’ 108 (Refer to FIG. 2)

Step1: Project Info
   Project name, client info, background, research objective, recruiting & sample info [Quote Form], Assigned responsibilities, Pricing, Discussion dates/times,
   payments [Payment process]
Step2: Sample & Recruiting
   Upload participant contact files, manage group attendees and confirm group details
Step3: Invitations and Reminders
   Invite and remind participants, observers and the administrator of the discussion via e-mail and phone
Step4: Discussion Guide
   Upload and view questions for discussion
Step5: Visual Slides
   Create and view visual slides for discussion
Step6: Practice
   Provide access to the Discussion Room with discussion guide and visual slides
Step7: Live Discussion
   Provide access to Discussion Room at schedule date and time
Step8: Transcripts
   Select available discussion, view/filter/flag text comments, download transcript of discussion
Step9: Incentives
   Provide list of actual participants, select for payment
Step10: Report
   Generate text from user input and data collected as a report template for user

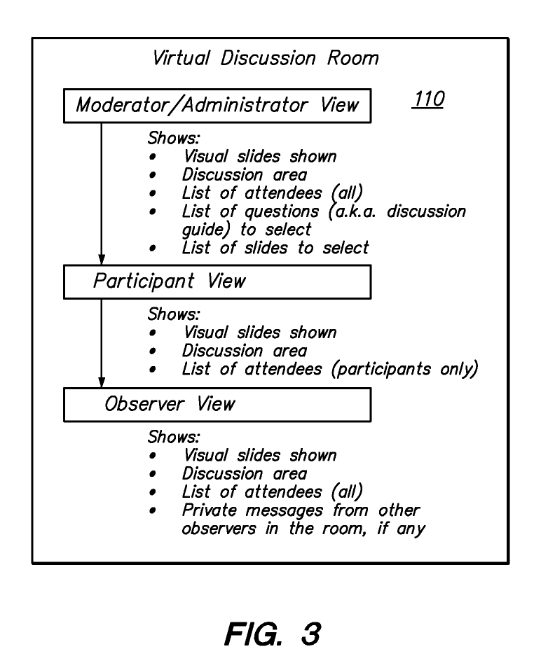

The Quote form and payment process screens are not provided here. The Virtual Discussion Room 110 is managed by the Practice and Discussion functions above, and is further explicated in FIG. 3

The Virtual Discussion Room 110 function provides three parallel views of the group discussion, a Moderator/Administrator View, a Participant View, and an Observer View, as shown in FIG. 3.

The Moderator/Administrator View has the largest number of functions enabled by the invention. Moderators/Administrators can select the communication formats (text, audio, video), type in the message box for sending to the text conversation, select from the list of questions to be posed to the Participants and propose them, as well as select the slides to be presented. Moderators/Administrators can private message any attendee.

All discussion attendees see all the slides and the discussion area. Participants do not see Observers noted in the attendees list, nor do they see or hear any conversation text from Observers. Observers can view Participant details. Private messages can be exchanged among Observers, and between Observers and the Moderator/Administrator, but not between Observers and Participants, or among Participants.

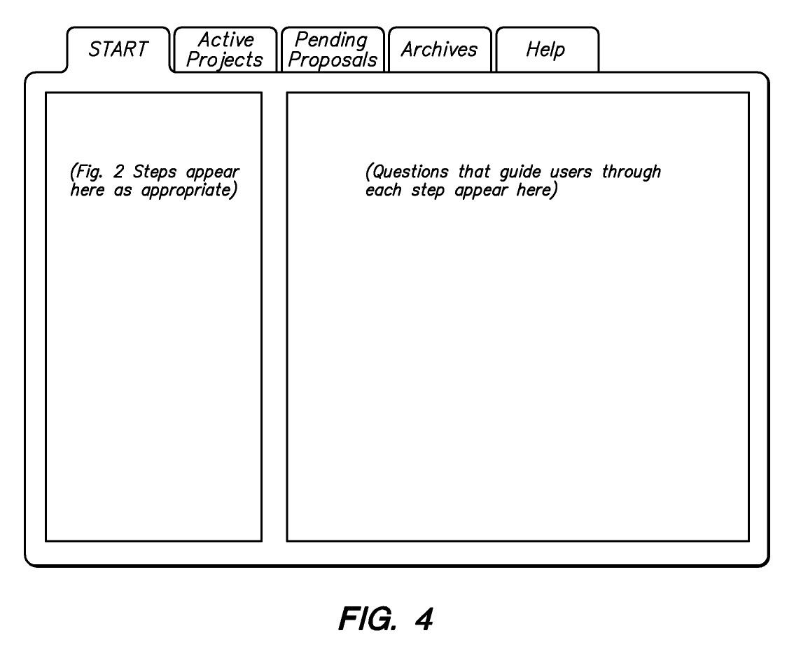

The generic screen format of the Virtual Office is shown in FIG. 4, with selectable tabs at the top of the page to move among the Virtual Office functions.

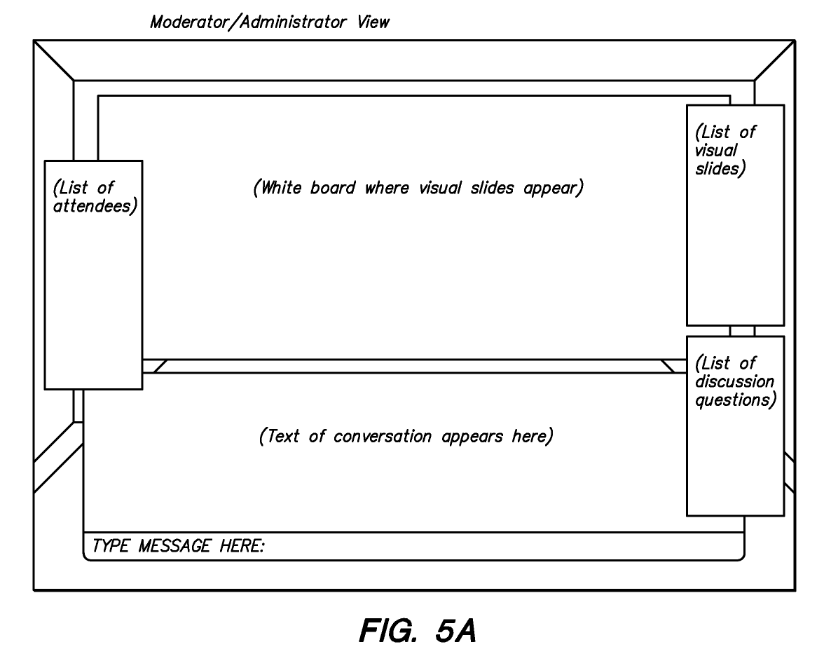

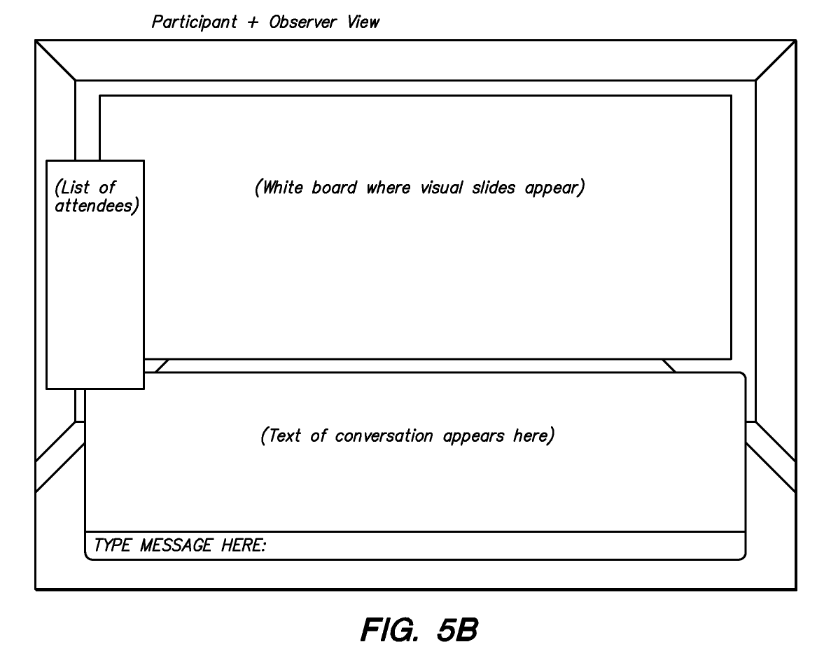

FIG. 5A and FIG. 5B show the screen format for the Virtual Discussion Room, with the two main fields of “white board” for slides and a chat screen for text conversation below.

While the foregoing describes a preferred mode and an alternate embodiment, variation on this design and equivalent methods may be resorted to in the scope and spirit of the claimed invention.

What is claimed is:

1. An online qualitative research support system comprised of a Virtual Office system and a Virtual Discussion Room system,
the Virtual Office system, comprised of a new project function, an existing projects function, a pending proposals function, an archived projects function, and a help function,
the Virtual Office system also comprised of a project information function, a sample and recruiting function, and invitation and reminders function, a discussion guide function, a visual slides support function, a practice function, a live discussion function, a transcripts function, an incentives function, and a report function,
the practice function and live discussion function together comprising the Virtual Discussion Room function,
the Virtual Discussion Room providing three parallel views of a distributed discussion session, the three views comprised of a moderator/administrator view, a participant view, and an observer view,
the online qualitative research support system implemented on a distributed computer network, comprised of geographically separated computers electronically linked to each other by means of a distributed communication system,
the distributed communication system selected from a list comprised of text/audio/video recording mechanisms, information input mechanisms, and internet connections.

2. The online qualitative research support system as in claim 1, where one of the geographically separated computers is an Internet Service Provider possessing a database repository where archived projects and proposals are stored and the distributed communication system is the Internet.

3. A method of using a qualitative research support system as in claim 1 comprising the steps of
logging in to the online qualitative research support system,
defining a new project with the project information function,
uploading participant contact files from database repository by means of the sample and recruiting function,
inviting participants, observers, and the group administrator by means of the invitations and reminders function,
uploading questions by means of the discussion guide function,
creating slides to project database by means of the visual slides function,
providing user access to the virtual discussion room by means of the practice function,
providing user access to the virtual discussion room by means of the live discussion function,
accumulating participant responses to the moderator's submitted stimuli via internet-connected computers used by discussion attendees via the Virtual Discussion Room system,
downloading, sorting, filtering and flagging transcripts of participant responses by transcript function,
identifying participant duration in the room and collecting contact information to distribute incentives by the incentive function, and
generating reports on session discussions using report function.
